(19) United States
(12) Patent Application Publication
(10) Pub. No.: US 2002/0144246 A1
(43) Pub. Date: Oct. 3, 2002

(54) Method and apparatus for lexical analysis

(75) Inventor: Seong R. Yu, Austin, TX (US)

Correspondence Address: Frank C. Nicholas, CARDINAL LAW GROUP, 1603 Orrington Avenue, Suite 2000, Evanston, IL, 60201, US

(73) Assignee: IBM Corporation

(21) Appl. No.: 09/820,499

(22) Filed: Mar. 29, 2001

(51) Int. Cl. G06F 9/44

(52) U.S. Cl. 717/143

(57) ABSTRACT

A lexical analyzer for processing computer programming languages is provided. The lexical analyzer can detect single character or multi-character delimiters, as well as single and/or multi-character delimiter-tokens included in an input stream. In response to detecting a delimiter, the lexical analyzer returns a token representing a string immediately preceding the delimiter in the input stream. Upon detecting a delimiter-token, the lexical analyzer stores the delimiter-token, and returns it on a subsequent call to the analyzer.

### BACKGROUND OF THE INVENTION

1. Field of the Invention

The present invention relates generally to software development tools, and in particular, to lexical analyzers capable of accepting single and multiple character delimiters.

2. Description of the Related Art

Lexical analyzers are used in many areas of computer science for a multitude of applications. The main task of a lexical analyzer is to read input characters from a source program and produce as output a sequence of tokens. This process is called “tokenization” because the process generates a sequence of output tokens representing strings contained in the input source program. The identification of strings and delimiters is a necessary task for many language processing tasks.

In the past, lexical analyzers have been built to recognize multi-byte character sets. U.S. Pat. No. 5,317,509, assigned to Hewlett-Packard Company, discloses such a lexical analyzer. Although the lexical analyzer in the '509 patent is capable of tokenizing multi-byte characters, it is not designed to recognize multi-character delimiters and multi-character delimiter-tokens.

U.S. Pat. No. 6,016,467, assigned to Digital Equipment Corporation, discloses a lexical analyzer that is useful for such tasks as updating various multimedia indices. However, like the lexical analyzer of '509 patent, the lexical analyzer of the '467 patent is not designed for recognizing multi-character delimiters and multi-character delimiter-tokens.

The lexical analyzer in U.S. Pat. No. 5,802,262, assigned to Sun Microsystems, Inc., allows for diagnosis of lexical errors in an input stream of symbols. Like the lexical analyzers discussed above, the lexical analyzer of the '262 patent does not rely on multi-character (string) delimiters or string delimiter-tokens.

The Java TM programming language developed by Sun Microsystems, Inc. includes a StreamTokenizer class. This tokenizer class only accepts single character delimiter-tokens that it refers to as ordinary characters. The StreamTokenizer class does not accept multi-character delimiter-tokens.

The ability to recognize string delimiters and string delimiter-tokens is a capability that is important for processing some contemporary programming languages, such as Java and HTML (hypertext mark up language). Accordingly, there is a need for an improved lexical analyzer and method that recognize string delimiters and delimiter-tokens.

### SUMMARY OF THE INVENTION

In view of the foregoing, the present invention provides an apparatus and method for lexical analysis that can recognize string delimiters and/or string delimiter-tokens. To accomplish this, a string delimiter-token table and string delimiter table are provided, which are accessible to a lexical analyzer configured to identify string delimiters and delimiter-tokens.

According to one embodiment of the present invention, a computer-based lexical analyzer is provided. The lexical analyzer receives an input stream of characters, which can represent a programming language. A delimiter is then detected in the input stream. The delimiter can be either a single character delimiter or a multi-character (string) delimiter. Upon detecting the delimiter, a token is returned. The token can represent a string of one or more characters occurring in the input stream, prior to the delimiter.

The present invention results in a lexical analyzer that is capable of tokenizing contemporary programming languages, such as Java™, that include multi-character delimiters and delimiter-tokens.

### BRIEF DESCRIPTION OF THE DRAWINGS

FIG. 1 is a block diagram of a system in accordance with the present invention;

FIG. 2 is a flowchart illustrating a method of operating the lexical analyzer of FIG. 1, in accordance with the present invention; and

FIG. 3 is a decision table illustrating the actions taken be the lexical analyzer during its operation.

### DETAILED DESCRIPTION OF THE PRESENTLY PREFERRED EMBODIMENTS

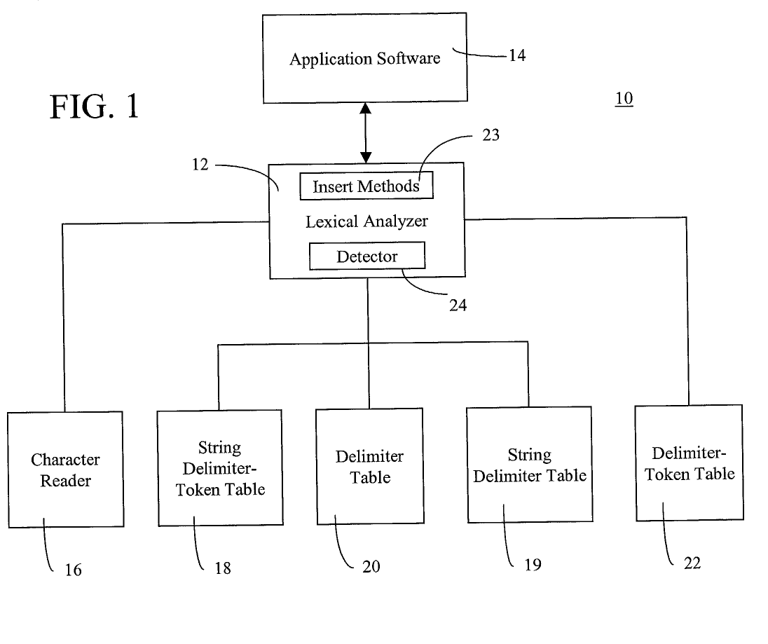

Turning now to the drawings, and in particular to FIG. 1, there is illustrated a system 10 in accordance with an embodiment of the present invention. The system 10 includes a lexical analyzer, or tokenizer, 12, which is operatively associated with a character reader 16, a string delimiter-token table 18, a string delimiter table 19, a delimiter table 20, and a delimiter-token table 22.

The lexical analyzer 12 reads an input stream and returns tokens. The lexical analyzer 12 includes a detector 24 for detecting delimiters or delimiter-tokens in the input stream. The delimiters can be single character delimiters or multi-character delimiters. Likewise, the delimiter-tokens can also consist of single or multiple characters.

An application software program 14 can call the lexical analyzer 12 to generate the tokens. The application software 14 provides an input stream to the lexical analyzer 12, which, in turn, calls the character reader 16 to read the stream one character at a time. The character reader 16 can be a standard software routine that returns a sequence of individual characters included in an input stream of characters.

The application 14 can be any type of software program requiring the services of a tokenizer, such as a parser or compiler.

Delimiters recognized by the lexical analyzer 12 are stored in the delimiter table 20. The delimiters are user-defined single characters that mark the boundaries of tokens. Delimiters can be any ASCII characters, such as the space character, tab character, greater-than character, or the like. The tokens are defined in terms of the user-defined delimiters. Any characters occurring between delimiters are considered to be part of a token.

The string delimiter table 19 stores multi-character delimiters. Multi-character delimiters can consist of two or more user-defined ASCII characters.

Delimiter-tokens recognized by the lexical analyzer 12 are stored in the delimiter-token table 22. Delimiter-tokens are essentially tokens that play a role as delimiters also. For example, the symbol “=” is a token and a delimiter, i.e., a delimiter-token. An input stream “count=2”, will return the tokens “count”, “=”, and “2” as tokens by using the “=” as a delimiter.

String delimiter-tokens recognized by the lexical analyzer 12 are stored in the string delimiter-token table 18. As an example of a string delimiter-token, the symbol “**” can be a token and a delimiter in a math equation “x**3” to denote x to the power of 3. Thus, the symbol “**” is a string delimiter-token. An input stream of “x**3”, would return the tokens “x”, “**”, and “3” as tokens by using the “**” as a delimiter.

As another example of string delimiter-tokens, the Java Server Page (JSP) and HTML (hypertext markup language) comment strings are tokens and also act as delimiters. For instance, the string “←” (excluding the double quotes) is a begin comment string in JSP. The string “→” (excluding the double quotes) is an end comment string in JSP. Any character(s) occurring between a delimiter and one of the comment strings are returned together as a token. The comment string can be subsequently returned by the lexical analyzer 12 as a token. The ability to define and identify multi-character special delimiter-tokens is the advantage of the lexical analyzer 12.

The lexical analyzer 12 can optionally include insert methods 23 for each table 16-22. The methods 23 permit a user to update the symbols stored in the tables 16-22. For example, a call to method addDelimitero can insert an ACSII character for a particular delimiter, such as a character space, into the delimiter table 20.

The programming signatures for each of the methods can be:

addDelimiter(int)

addDelimiterToken(int)

addStringDelimiter(String)

addStringDelimiterToken(String)

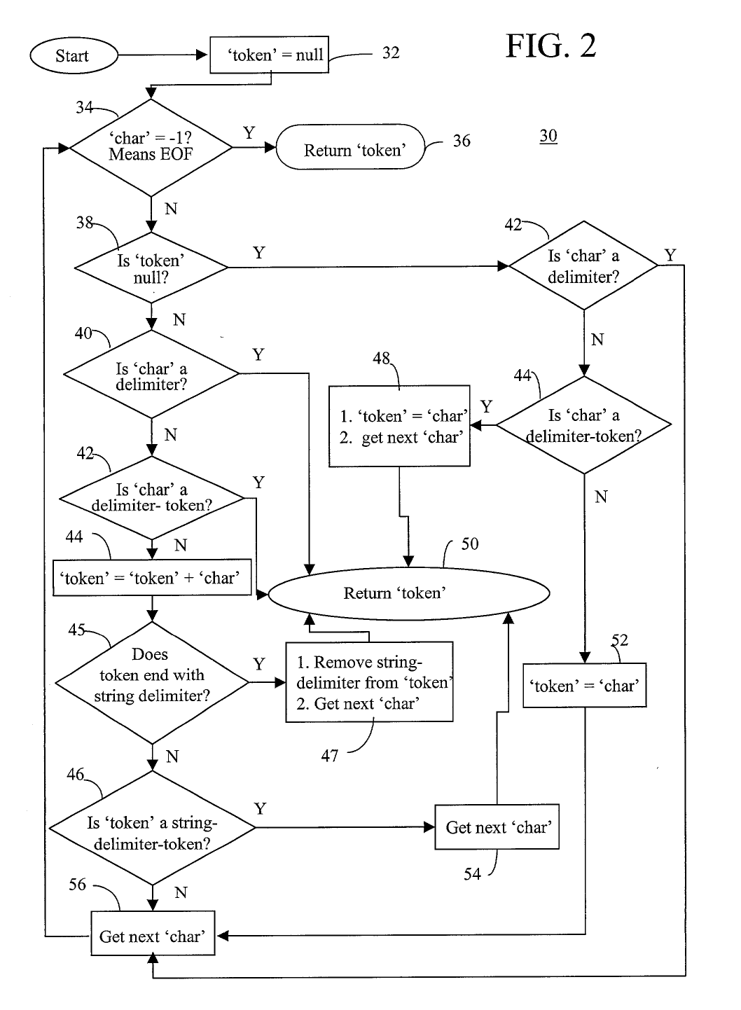

FIG. 2 is a flowchart 30 illustrating a method of operating the lexical analyzer 12 of FIG. 1, in accordance with the present invention. In general terms, the lexical analyzer 12 performs a looping operation until a token has been determined in an input stream, and returns the token to the calling program. A token is determined when either a delimiter or a delimiter-token has been determined. If a delimiter-token has been determined, then in a subsequent call to the lexical analyzer 12, the delimiter-token is returned as token. Special handling is required when multi-character delimiters used.

In step 32, the token and character (“char”) variables are initialized. The token variable is set to null, and the character variable is set to a predetermined value represented as initChar.

Next, a check is made to determine whether the end of the input stream has been reached (step 34). This is accomplished by checking for an end-of-file (“EOF”) character, such as −1. If the EOF is reached, the token represented by the token variable is returned by the lexical analyzer 12 to the calling application 14. Otherwise, the lexical analyzer 12 performs a looping operation to determine the next character.

In step 38, a check is made to determine whether the token variable is null. If so, the method proceeds to step 42, where a check is made to determine whether the character variable is a delimiter. This check is performed by the detector 24 accessing the delimiter table 20 and comparing the char variable against values stored therein. If the character variable is a delimiter, the lexical analyzer 12 gets the next character from the input stream (step 56), preferably using the character reader 16, and returns to step 34.

If the character variable is not a delimiter, the method proceeds to step 44, where a check is made to determine whether the character variable is a delimiter-token. This is accomplished by the detector 24 comparing the character variable to the delimiter-token table 22. If character is not a delimiter-token, the token variable is set to the character variable (step 52), and the lexical analyzer 12 gets the next character from the input stream 54.

However, if the character variable represents a delimiter-token in step 44, the token variable is set to the character variable and the next character is read from the input stream (step 48). The token is then returned by the lexical analyzer 12 (step 50).

Turning now back to step 38, if the token variable is not set to null, a check is made to determine whether the character variable is a delimiter (step 40). If so, the value of the token variable is returned (step 50).

However, if the character variable is not a delimiter, a check is made to determine whether the character variable represents a delimiter-token (step 42). If so, the lexical analyzer 12 returns the token variable (step 50). If not, the value of the character variable is appended to the token variable (step 44).

In step 45, a check is made to determine whether the token variable ends with a string delimiter. This action is performed by the detector 24 comparing the token variable to the string delimiter table 19. If the token does not end with a string delimiter, the method proceeds to step 46. However, if the token ends with a string delimiter, the string delimiter is removed from the token variable and the next character is read from the input stream (step 47). The token is then returned (step 50).

In step 46, a check is made to determine whether the token variable is a string delimiter-token. This is accomplished by the detector 24 comparing the token variable to the sting delimiter-token table 18. If the variable represents a string delimiter-token, the lexical analyzer 12 gets the next character in the input stream (step 54), and then returns the value of the token variable (step 50). If not, the analyzer 12 gets the next character (step 56) and returns to step 34.

The delimiter-token and string-delimiter-token are not tossed away and they are returned as token. They play role of delimiter and token.

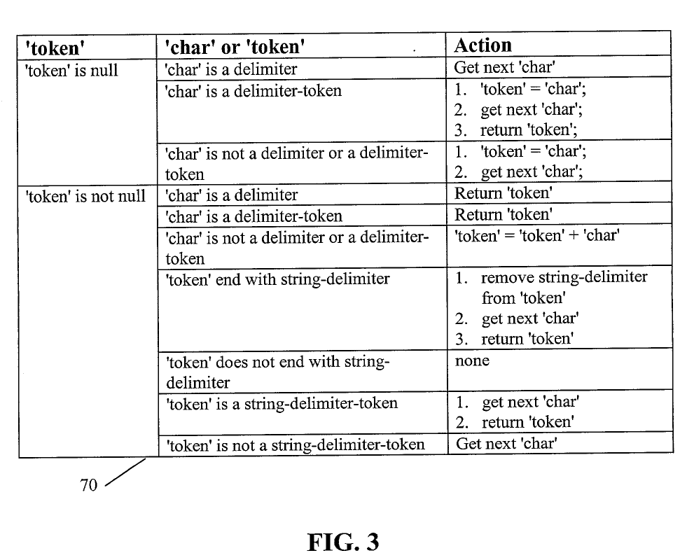

FIG. 3 is a decision table 70 illustrating the decision logic of the lexical analyzer 12 during its operation. In the left-most column, a check is made to determine whether the token is set to null. In the middle column, the character variable (char) is scrutinized. Based on the values of the token and character variables, the actions defined in the right-most column are taken.

The lexical analyzer and method described herein can be used to identify deprecated statements in software code that is being migrated to newer versions of a particular programming language, such as Java TM. Deprecated statements are software constructs or language that are no longer supported by later versions of a language. According to one embodiment of the invention, symbols representing deprecated statements can be entered into the delimiter-token tables 18, 22 to be specifically identified by the lexical analyzer 12. Alternatively, the lexical analyzer 12 can return tokens representing deprecated statements, the tokens being identified as such by the application software 14.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of lexical analysis, comprising:
receiving an input stream of characters;
detecting a delimiter in the input stream, the delimiter being selected from the group consisting of a single character delimiter and a multi-character delimiter; and
returning a token upon detecting the delimiter.

2. The method of claim 1, further comprising:
reading the input stream one character at a time.

3. The method of claim 1, further comprising:
forming the token by appending to a string at least one of the input stream characters preceding the delimiter.

4. The method of claim 1, further comprising:
detecting a delimiter-token;
returning the token upon detecting the delimiter token.

5. The method of claim 4, further comprising:
returning the delimiter-token.

6. The method of claim 5, where in the delimiter-token is returned on a sub sequent call to a lexical analyzer.

7. The method of claim 1, wherein the step of detecting includes:
comparing at least one of the input stream characters to a single character delimiter table and a multiple character delimiter table.

8. The method of claim 1, for use in migrating pre-existing software code from a first version to a second version of a predetermined language.

9. A lexical analyzer, comprising:
an input for receiving an input stream of characters;
a detector for detecting a delimiter in the input stream, the delimiter being selected from the group consisting of a single character delimiter and a multi-character delimiter; and
an output for returning a token upon detecting the delimiter.

10. The lexical analyzer of claim 9, further comprising:
means for forming the token by appending to a string at least one of the input stream characters preceding the delimiter.

11. The lexical analyzer of claim 9, further comprising:
means for detecting a delimiter-token;
means for returning the token upon detecting the delimiter-token.

12. The lexical analyzer of claim 11, wherein the delimiter-token is returned on a subsequent call to the lexical analyzer.

13. The lexical analyzer of claim 9, wherein the detector includes:
a comparator for comparing at least one of the input stream characters to a single-character delimiter table and a multiple-character delimiter table.

14. The lexical analyzer of claim 9, for use in migrating pre-existing software code from a first version to a second version of a predetermined language.

15. Computer program product in a computer-usable medium, comprising:
means for receiving an input stream of characters;
means for detecting a delimiter in the input stream, the delimiter being selected from the group consisting of a single character delimiter and a multi-character delimiter; and
means for returning a token upon detecting the delimiter.

16. The computer program product of claim 9, further comprising:
means for forming the token by appending to a string at least one of the input stream characters preceding the delimiter.

17. The computer program product of claim 9, further comprising:
means for detecting a delimiter-token; and
means for returning the token upon detecting the delimiter-token.

18. The computer program product of claim 11, wherein the delimiter-token is returned on a subsequent call to the computer program product.

19. The computer program product of claim 9, wherein the detector includes:
means for comparing at least one of the input stream characters to a single-character delimiter table and a multiple-character delimiter table.

20. The computer program product of claim 9, for use in migrating pre-existing software code from a first version to a second version of a predetermined language.
